(19) United States
(12) Patent Application Publication
(10) Pub. No.: US 2019/0333098 A1
(43) Pub. Date: Oct. 31, 2019

(54) METHOD AND SYSTEM TO DETECT ADVERTISEMENT FRAUD

(71) Applicant: Affle (India) Limited, Mumbai City (IN)

(72) Inventors: Anuj Khanna SOHUM, Singapore (SG); Charles Yong Jien FOONG, Singapore (SG); Anurag SINGH, Gurgaon (IN)

(73) Assignee: Affle (India) Limited, Mumbai City (IN)

(21) Appl. No.: 16/399,618

(22) Filed: Apr. 30, 2019

(30) Foreign Application Priority Data
Apr. 30, 2018 (IN) 201821016229

(51) Int. Cl. G06Q 30/02; H04L 29/06

(52) U.S. Cl. CPC G06Q 30/0248; H04L 63/1425; G06Q 30/0246

(57) ABSTRACT

The present disclosure provides a method and system to detect advertisement fraud. The fraud identification system receives a traffic data initiated through a plurality of users. In addition, the fraud identification system clusters the traffic data into slots of install based on one of a plurality of criteria and determine high conversion rate and low conversion rate. Further, the fraud identification system analyzes deviation of the high conversion rate and the low conversion rate with a pre-defined threshold. Furthermore, the fraud identification system analyzes the slots of install for which difference between the average of the high conversion rate and the low conversion rate is above the pre-defined threshold. Also, the fraud identification system segregates incentive traffic and non-incentive traffic based on the analysis. The segregation is done to generate report of the traffic data and determine incentive time.

### TECHNICAL FIELD

The present disclosure relates to the field of fraud detection systems and, in particular, relates to a method and system to detect advertisement fraud based on incentive and non-incentive traffic.

### INTRODUCTION

With the advancements in technology over the last few years, users have predominantly shifted towards smartphones for accessing multimedia content. Nowadays, users access content through a number of applications available for download through various online application stores. Businesses (Advertisers) have started focusing on generating revenue by targeting consumers through these applications. In addition, businesses have started investing heavily in doing business with these applications. Moreover, businesses (publishers and/or advertising networks) have started developing capable advertisement applications for serving advertisements through these applications. These advertisements are published in real time or fixed placements through these applications and watched by the users. The advertisers are benefited in terms of internet traffic generated by clicking, taking action like installing or on watching these advertisements. However, certain online publishers and advertising networks working with these publishers take undue advantage of this in order to generate high revenues. These online publishers and advertising networks employ fraudulent techniques in order to generate clicks or to increase actions like increasing number of application install for the advertisers through fraudulent means. In addition, these online publishers incentivize the users for clicking on links, downloading applications and the like. This results in a loss of advertisers marketing budget spent as many times these publishers claim a normal user-initiated action (Organic action, e.g. Organic Install) as one initiated by them or at times the clicks or application installs are not driven by humans at all and instead by bots. There is a consistent need to stop publishers from performing such types of click fraud and transaction fraud.

### SUMMARY

In a first example, a computer system is provided. The computer system includes one or more processors and a memory. The memory is coupled to the one or more processors. The memory stores instructions. The instructions are executed by the one or more processors. The execution of instructions causes the one or more processors to perform a method for detecting advertisement fraud based on incentive traffic and non-incentive traffic. The method includes a first step of receiving a traffic data initiated through a plurality of media devices at a fraud identification system. The method includes another step of clustering the traffic data into slots of install at the fraud identification system. The method includes yet another step of determining a high conversion rate and a low conversion rate for the slots of install at the fraud identification system. The method includes yet another step of analyzing deviation of the high conversion rate and the low conversion rate with a pre-defined threshold at the fraud identification system. The method includes yet another step of analyzing slots of install for which difference between the average of the high conversion rate and the low conversion rate is above a pre-threshold at the fraud identification system. The method includes yet another step of segregating incentive traffic and non-incentive traffic based on the analysis at the fraud identification system. The traffic data is generated when one or more advertisements are viewed on at least one publisher on the plurality of media devices. The clustering is done based on one of a plurality of criteria by an adaptive slot grouping engine. The clustering is done after receiving the traffic data in real time. The determination is done by using segmentation statistical models in real time. The determination is done for the slots of install where the number of install is above a minimum install based on examination of user behavior. The analysis is done to identify fraud in the traffic data. The analysis is done when a signal generator circuitry embedded inside a plurality of media devices generates a signal to trigger one or more hardware components of the plurality of media devices. The analysis is done in real time. The segregation is done to generate report of the traffic data. The segregation is done to determine an incentive time in real time.

In an embodiment of the present disclosure, the plurality of criteria includes a number of installs, time-interval and historical trends.

In an embodiment of the present disclosure, the device data includes a number of application install, a number of application uninstalled, time-stamp, location, operating system, network type, service provider, location, model number, network speed and device type.

In an embodiment of the present disclosure, the application data includes network download time, application usage time, application idle time, application opening time, application size, time to download, time to run, click to install, click to run, user click time, device load time, time to run and time to install.

In an embodiment of the present disclosure, the fraud identification system identifies the user behavior from device data, application data, past data and third party database. The user behavior includes user routine, time stamp, user interactions and application usage data.

In an embodiment of the present disclosure, the fraud identification system examines the user behavior to identify a downtime and the minimum install. The examination is done based on real-time data and user behavior. The examination is done in real time.

In an embodiment of the present disclosure, the fraud identification system determines the incentive time for incent mixing is performed based on the analysis. The determination is done in real time.

In an embodiment of the present disclosure, the fraud identification system blocks the publisher performing fraud in the one or more advertisements based on the analysis of the traffic data. The blocking is done in real time.

In a second example, a computer-implemented method is provided. The computer-implemented method detects advertisement fraud based on incentive and non-incentive traffic. The computer-implemented method includes a first step of receiving a traffic data initiated through a plurality of media devices at a fraud identification system with a processor. The computer-implemented method includes another step of clustering the traffic data into slots of install at the fraud identification system with the processor. The computer-implemented method includes yet another step of determining a high conversion rate and a low conversion rate for the slots of install at the fraud identification system with the processor. The computer-implemented method includes yet another step of analyzing deviation of the high conversion rate and the low conversion rate with a pre-defined threshold at the fraud identification system with the processor. The computer-implemented method includes yet another step of analyzing slots of install for which difference between the average of the high conversion rate and the low conversion rate is above a pre-threshold at the fraud identification system with the processor. The computer-implemented method includes yet another step of segregating incentive traffic and non-incentive traffic based on the analysis at the fraud identification system with the processor. The traffic data is generated when one or more advertisements are viewed on at least one publisher on the plurality of media devices. The clustering is done based on one of a plurality of criteria by an adaptive slot grouping engine. The clustering is done after receiving the traffic data in real time. The determination is done by using segmentation statistical models in real time. The determination is done for the slots of install where the number of install is above a minimum install based on examination of user behavior. The analysis is done to identify fraud in the traffic data. The analysis is done when a signal generator circuitry embedded inside a plurality of media devices generates a signal to trigger one or more hardware components of the plurality of media devices. The analysis is done in real time. The segregation is done to generate report of the traffic data. The segregation is done to determine an incentive time in real time.

In an embodiment of the present disclosure, the plurality of criteria includes a number of installs, time-interval and historical trends.

In an embodiment of the present disclosure, the device data includes a number of application install, a number of application uninstalled, time-stamp, location, operating system, network type, service provider, location, model number, network speed and device type.

In an embodiment of the present disclosure, the application data includes network download time, application usage time, application idle time, application opening time, application size, time to download, time to run, click to install, click to run, user click time, device load time, time to run and time to install.

In an embodiment of the present disclosure, the fraud identification system identifies the user behavior from device data, application data, past data and third party database. The user behavior includes user routine, time stamp, user interactions and application usage data.

In an embodiment of the present disclosure, the fraud identification system examines the user behavior to identify a downtime and the minimum install. The examination is done based on real-time data and user behavior. The examination is done in real time.

In an embodiment of the present disclosure, the fraud identification system determines the incentive time for incent mixing is performed based on the analysis. The determination is done in real time.

In an embodiment of the present disclosure, the fraud identification system blocks the publisher performing fraud in the one or more advertisements based on the analysis of the traffic data. The blocking is done in real time.

In a third example, a non-transitory computer-readable storage medium is provided. The non-transitory computer-readable storage medium encodes computer executable instructions that, when executed by at least one processor, performs a method. The method detects advertisement fraud based on incentive and non-incentive traffic. The method includes a first step of receiving a traffic data initiated through a plurality of media devices at a computing device. The method includes another step of clustering the traffic data into slots of install at the computing device. The method includes yet another step of determining a high conversion rate and a low conversion rate for the slots of install at the computing device. The method includes yet another step of analyzing deviation of the high conversion rate and the low conversion rate with a pre-defined threshold at the computing device. The method includes yet another step of analyzing slots of install for which difference between the average of the high conversion rate and the low conversion rate is above a pre-threshold at the computing device. The method includes yet another step of segregating incentive traffic and non-incentive traffic based on the analysis at the computing device. The traffic data is generated when one or more advertisements are viewed on at least one publisher on the plurality of media devices. The clustering is done based on one of a plurality of criteria by an adaptive slot grouping engine. The clustering is done after receiving the traffic data in real time. The determination is done by using segmentation statistical models in real time. The determination is done for the slots of install where the number of install is above a minimum install based on examination of user behavior. The analysis is done to identify fraud in the traffic data. The analysis is done when a signal generator circuitry embedded inside a plurality of media devices generates a signal to trigger one or more hardware components of the plurality of media devices. The analysis is done in real time. The segregation is done to generate report of the traffic data. The segregation is done to determine an incentive time in real time.

### BRIEF DESCRIPTION OF DRAWINGS

Having thus described the invention in general terms, references will now be made to the accompanying figures, wherein:

FIG. 1A illustrates an interactive computing environment for identification of advertisement fraud in real time, in accordance with various embodiments of the present disclosure;

FIG. 1B illustrates a block diagram of various components of the interactive computing environment for the detection of fraud in the advertisements, in accordance with various embodiments of the present disclosure;

FIG. 2 illustrates a flow chart of a method for identification of advertisement fraud in real time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

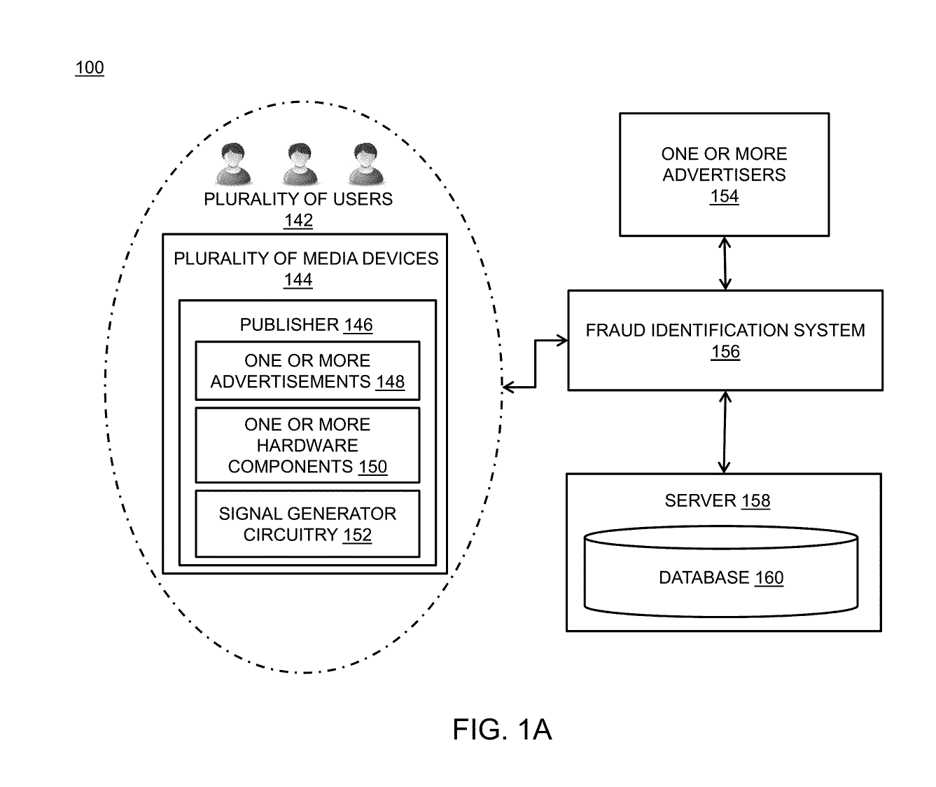

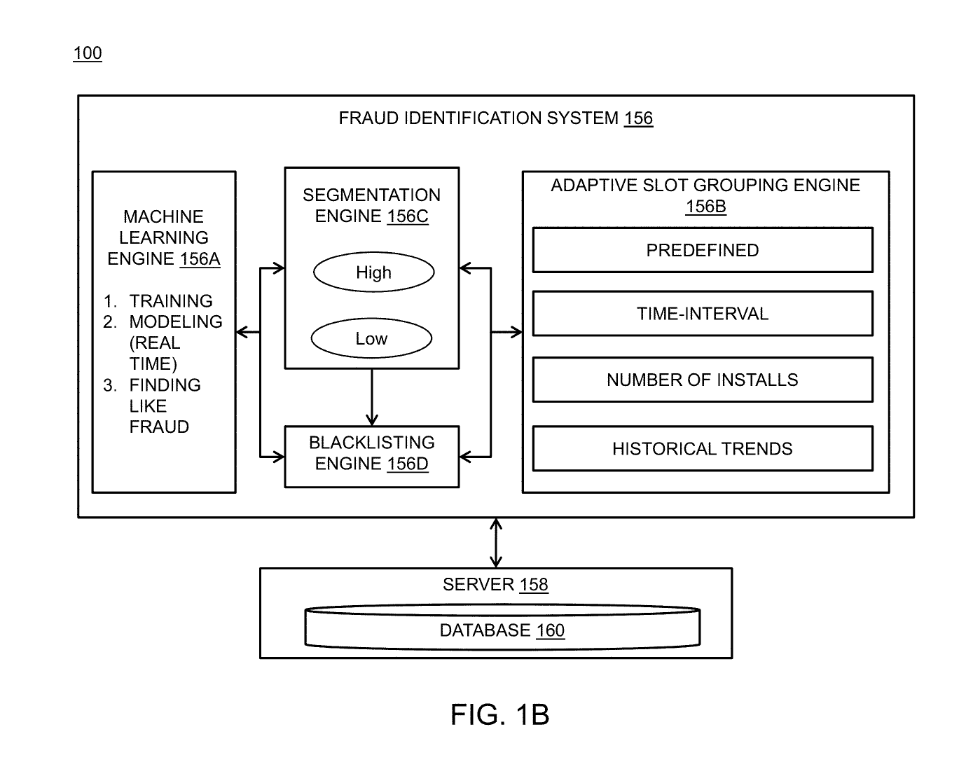

FIG. 1A illustrates an interactive computing environment 100 for detection of an advertisement fraud in real time, in accordance with various embodiments of the present disclosure. The interactive computing environment 100 shows a relationship between various entities involved in detection of fraud in one or more advertisements 148 based on incentive traffic and non-incentive traffic. The advertisement fraud is a type of fraud which is being done to generate more revenue from the one or more advertisements 148 being displayed by generating fake install or clicks. The fake install is done with the help of software, bots. The fake install or fake traffic is faked through techniques such as click fraud, transaction fraud and the like. The click fraud corresponds to regular or constant clicking by at least one of a plurality of users 142 on the one or more advertisements 148 in order to generate more revenue for a publisher 146. The click fraud is when the publisher 146 gets paid based on pay-per-click or pay-per-view bases whenever the one or more advertisements 148 get clicked. The click fraud refers to the generation of fraudulent clicks through online bots which are not identifiable and are treated as genuine install. The transaction fraud refers to initiating install via fake clicks and bots (as described above in the application). The transaction fraud takes place when the publisher 146 applies fraudulent techniques to drive fake installs of applications in order to generate more revenue.

The incentive traffic or incent traffic corresponds to advertisement traffic generated by clicking on the one or more advertisements 148, installing an application after clicking on the one or more advertisement 148 and the like. The incentive traffic is generated when the plurality of users 142 is rewarded by the publisher 146 for clicking on the one or more advertisements 148, installing an application, and the like. The plurality of users 142 is rewarded by giving points, coins, lifeline, in-app purchase and the like. The plurality of users 142 may be redirected to a website associated with one or more advertisers 154 after clicking on the one or more advertisements 148. The incentive traffic includes a list of users who do not use the applications actively or uninstall the one or more advertisers 154 application after some time. The plurality of users 142 in the incentive based traffic click on the one or more advertisements 148 or watch the one or more advertisements 148 for their own purposes. In an example, a user click on an advertisement to earn some points for a game he or she is playing on a device.

The non-incentive traffic or non-incent traffic corresponds to the advertisement traffic wherein no benefit is provided to the plurality of users 142 for clicking or downloading the one or more advertisements 148. The non-incentive traffic is a list of users who click on the one or more advertisements 148 as per their choice with no such incentive to lure the plurality of users 142. In addition, the non-incentive traffic is a list of the plurality of users 142 who are interested in using the one or more advertisers 154 application or interested in what the one or more advertisements 148 is about.

The interactive computing environment 100 includes the plurality of users 142, a plurality of media devices 144, the publisher 146 and the one or more advertisements 148. Further, the interactive computing environment 100 includes one or more hardware components 150, a signal generator circuitry 152, the one or more advertisers 154, a fraud identification system 156, a server 158 and a database 160. In addition, the fraud identification system 156 includes a plurality of components (as shown in FIG. 1B). The plurality of components includes a machine learning engine 156A, adaptive slot grouping engine 156B, segmentation engine 156C and a blacklisting engine 156D. Each of the components of the interactive computing environment 100 interacts with each other to enable detection of advertisement fraud in real time based on incentive and non-incentive traffic.

The interactive computing environment includes the plurality of users 142 who is any person present at any location and accessing the multimedia content. The plurality of users 142 is any legal person or natural person who access online multimedia content and need an IP based network for accessing the multimedia content. In addition, the plurality of users 142 is an individual or person who access online multimedia content on the plurality of media devices 144. Further, the plurality of users 142 is a computer or bots which is programmed to view the one or more advertisements 148 and performs click and transaction in order to do fraud. In an embodiment of the present disclosure, the plurality of users 142 includes but may not be limited to a natural person, legal entity, individual, machine and robots for viewing advertisement. The plurality of users 142 is associated with the plurality of media devices 144.

The interactive computing environment further includes the plurality of media devices 144 which help to communicate information. The plurality of media devices 144 includes but may not be limited to a Smartphone, a laptop, a desktop computer, a tablet and a personal digital assistant. In an embodiment of the present disclosure, the plurality of media devices 144 includes a smart television, a workstation, an electronic wearable device and the like. In an embodiment, the plurality of media devices 144 includes portable communication devices and fixed communication devices. In an embodiment of the present disclosure, the plurality of media devices 144 is currently in the switched-on state. The plurality of users 142 accesses the plurality of media devices 144 in real time. The plurality of media devices 144 are any type of devices having an active internet. The plurality of media devices 144 are internet-enabled device for allowing the plurality of users 142 to access the publisher 146. In an embodiment of the present disclosure, the plurality of users 142 is owner of the plurality of media devices 144. In another embodiment of the present disclosure, the plurality of users 142 is not the owner of the plurality of media devices 144. In addition, the plurality of media devices 144 are used for viewing an application which is installed on the plurality of media devices 144.

The interactive computing environment 100 further includes the publisher 146 which is used for viewing content on the plurality of media devices 144. The publisher 146 includes but may not be limited to mobile application, web application and website. The publisher 146 is the mobile application which displays content to the plurality of users 142 on the plurality of media devices 144. The content includes one or more publisher content, one or more video content and the like. The application or the publisher 146 accessed by the plurality of users 142 shows content related to interest of the plurality of users 142. In an example, the plurality of users 142 may be interested in watching online videos, reading blogs, play online games, accessing social networking sites and the like. The publisher 146 is the application developed by the application developer for viewing or accessing specific content. The publisher 146 or applications are advertisement supporting applications which are stored on the plurality of media devices 144. The publishers 146 or mobile applications are of many type which includes gaming application, a utility application, a service based application and the like. The publishers 146 provide space, frame, area or a part of their application pages for advertising purposes which is referred to as advertisement slots. The publisher 146 consists of various advertisement slots which depend on the choice of the publisher 146. The publishers 146 advertise products, services or businesses to the plurality of users 142 for generating revenue. The publisher 146 displays the one or more advertisements 148 on the plurality of media devices 144 when the plurality of users 142 is accessing the publisher 146.

The one or more advertisements 148 are a graphical or pictorial representation of the information in order to promote a product, an event, service and the like. In general, the one or more advertisements 148 are a medium for promoting a product, a service, or an event. The one or more advertisements 148 include text advertisement, video advertisement, graphic advertisement and the like. The one or more advertisements 148 are displayed in third party applications developed by application developers. The one or more advertisements 148 are presented to attract the plurality of users 142 based on his interest in order to generate revenue. The one or more advertisements 148 are presented to the plurality of users 142 on the publisher 146 based on interest of the plurality of users 142 which is shown for a specific period of time. The plurality of users 142 click on the one or more advertisements 148 and are re-directed to a website or application or application store associated with the one or more advertisements 148. The one or more advertisements 148 are provided to the publisher 146 by the one or more advertisers 154 who want to advertise their product, service through the publisher 146. The publisher 146 gets paid if the plurality of users 142 visits the application or website through the one or more advertisements 148 of the one or more advertisers 154. The number of plurality of users 142 who visits the one or more advertisements 148 through the publisher 146 generates more revenue for the publisher 146.

The one or more advertisers 154 are those who want to advertise their product or service and the like to the plurality of users 142. The one or more advertisers 154 approach the publisher 146 and provide the one or more advertisements 148 to be displayed for the plurality of users 142 on the publisher 146. The one or more advertisers 154 pay the publisher 146 based on the number of the plurality of users 142 being redirected or taking the product or services provided by the one or more advertisers 154.

The one or more advertisements 148 are placed on the advertisement slots in the publisher application on the plurality of media devices 144 associated with the plurality of users 142. The one or more advertisers 154 purchase the advertisement slots from the publisher 146. The one or more advertisements 148 are served based on a real-time bidding technique or a direct contract between the one or more advertisers 154 and the publisher 146. The one or more advertisers 154 provide the one or more advertisements 148 to advertising networks and information associated with advertising campaigns. The advertisement networks enable display of the one or more advertisements 148 in real time on the publisher 146 on behalf of the one or more advertisers 154. The advertising networks are entities that connect the one or more advertisers 154 to websites and mobile applications that are willing to serve advertisements.

The interactive computing environment 100 further includes the one or more hardware components 150 which are embedded inside the one or more media devices 144. The one or more hardware components 150 include but may not be limited to camera, microphone, LED, light sensor, proximity sensor and accelerometer sensor. The one or more hardware components 150 include but may not be limited to gyroscope, compass and the like. The one or more hardware components 150 are triggered when the signal generator circuitry 152 embedded inside the plurality of media devices 144 generates a signal to trigger the one or more hardware components 150.

The signal generator circuitry 152 is used for generating signal and to trigger the one or hardware components 150 associated with the plurality of media devices 144. The one or more hardware components 150 are triggered for one or more purposes. The one or more purposes include but may not be limited to sending, receiving, analyzing and the like. The one or more purposes include generating a signal based on the requirement of the fraud identification system 156. The signal generator circuitry 152 triggers the one or more hardware components 150 to perform a specific task in the plurality of media devices 144.

The interactive computing environment 100 further includes the fraud identification system 156 which is associated with the publisher 146 and the one or more advertisers 154. The fraud identification system 156 detects advertisement fraud by segregating the incentive based traffic with the non-incentive based traffic. The fraud identification system 156 detects advertisement fraud being done by the publisher 146 in order to generated fake traffic for the one or more advertisements 148. The fraud identification system 156 is linked with the publisher 146 which may be more than one in real time. The fraud identification system 156 is a platform for detecting incentive traffic being generated for a non-incentive based advertisement campaign. The fraud identification system 156 performs the detection of fraud in the one or more advertisements 148 in real time. The fraud identification system 156 performs the detection of fraud by performing sequence of tasks which includes but may not be limited to receiving traffic data, receiving device data. Further, the fraud identification system 156 performs the tasks of clustering the traffic data, identifying conversion rate, analysis, segregating and the like.

The fraud identification system 156 receives the traffic data initiated through the plurality of media devices 144. The traffic data is generated when the one or more advertisements 148 are viewed on at least one publisher 146 on the plurality of media devices 144. The traffic data is generated when the one or more advertisements 148 are clicked by the plurality of users 142. In general, the traffic data include the list of the plurality of users 142 who has clicked the one or more advertisements 148 of the one or more advertisers 154. The traffic data includes both the incentive traffic and the non-incentive traffic based data.

In addition, the fraud identification system 156 clusters a traffic data into slots of install. The clustering is done based on one of a plurality of criteria. The plurality of criteria includes number of installs, time-interval, historical trends and predefined. In an embodiment of the present disclosure, the plurality of criteria is any other criteria based on requirement of the fraud identification system 156. The clustering is done in real time by the adaptive slot grouping engine 156B as shown in FIG. 1B. The adaptive slot grouping engine 156B is used for grouping or clustering the traffic data into the slots of install. The number of install is selected than the number of installs in a day is used for clustering the traffic data into the slots of install. In an example, if the number of installs in a day are 10000 than the clustering can be done based on 1000 install periods, 2000 install periods, and the like.

In another embodiment of the present disclosure, the time-interval is used by the adaptive slot grouping engine 156B for clustering the traffic data. In an example, 24 hours a day can be divided into slots of install of 1 hour each based on the traffic data. In yet another embodiment of the present disclosure, the historical trends is used by the adaptive slot grouping engine 156B for the clustering of the traffic data. In an example, the historical trend shows the clustering being done based on the time-interval than it selects the time-interval for the clustering of the traffic data. In yet another embodiment of the present disclosure, the clustering method can be predefined which is used by the adaptive slot grouping engine 156B for the clustering of the traffic data.

Further, the fraud identification system 156 identifies user behavior from device data, application data, past data and third party database. The user behavior is identified by the machine learning engine 156A of the fraud identification system 156. The user behavior includes but may not be limited to user routine, time stamp, user interactions and application usage data. In an embodiment of the present disclosure, the device data includes a number of application install, a number of application uninstalled, time-stamp, location and the like. In another embodiment of the present disclosure, the device data includes but may not be limited to the operating system, network type, service provider and location. In yet another embodiment of the present disclosure, the device data includes but may not be limited to model number, device type network speed.

In an embodiment of the present disclosure, the application data includes but may not be limited to network download time, application usage time, and application idle time. In another embodiment of the present disclosure, the application data includes but may not be limited to network download time, application opening time and application size. In yet another embodiment of the present disclosure, the application data includes time to download, time to run, click to install, click to run, user click time, device load time, time to run and time to install. The third party database includes data which has been collected during past visits of the plurality of users 142 on third party publisher.

Furthermore, the fraud identification system 156 examines the user behavior to identify a downtime and minimum install. The downtime is the time during which the plurality of users 142 is inactive or not using the application due to which there is less traffic during such time-period. The downtime is the time during which there is less traffic on the number of clicks done by the plurality of users 142. The minimum install is the number of install that will be there in particular slots of install for it to be analyzed further. The minimum install is identified by the fraud identification system 156 based on the examination of the user behavior.

Furthermore, the fraud identification system 156 determines the high conversion rate and the low conversion rate for each slots of install where the number of install is above the minimum install. The determination is done at the segmentation engine 156C of the fraud identification engine 156. The conversion rate is the percentage of clicks on the one or more advertisements 148. In an example, if there are 10,000 clicks and 100 installs, then the conversion rate is 100/10000 which is 1%. The determination of the high conversion rate and the low conversion rate is done by using segmentation statistical models in real time. The segmentation statistical models include K-means algorithm with low and high seeds initially set to the low conversion rate and the high conversion rate.

In an example, if the plurality of users 142 is 2000 in city X than during the night hours there is inactivity of the number of users, this time of inactivity is considered as the downtime which would be around 6 hours. During the downtime there will be less number of the plurality of users 142 generating the traffic. The minimum install is the number of users clicking on the one or more advertisements 148 that would be around 300 users. Than the fraud identification system 156 will determine high conversion rate and the low conversion rate for those results which are having number of install more than the minimum install.

Moreover, the fraud identification system 156 analyzes deviation of the high conversion rate and the low conversion rate with a pre-defined threshold. The analysis is done when the signal generator circuitry 152 embedded inside the plurality of media devices 144 generates a signal. The signal is generated to trigger the one or more hardware components 150 of the plurality of media devices 144. The analysis is done at the machine learning engine 156A of the fraud identification system 156. The analysis is done of the high conversion rate and the low conversion rate for each of the slots of install. The pre-defined threshold is provided by the one or more advertisers 154. In an embodiment of the present disclosure, the pre-defined threshold is determined by the fraud identification system 156 based on the requirement of the one or more advertisers 154.

Moreover, the fraud identification system 156 segregates the incentive traffic and non-incentive traffic based on the analysis of the high conversion rate and the low conversion rate. The segregation is performed by the segmentation engine 156C. If the deviation is low than it is considered as the click spamming fraud is being committed in the traffic data. In addition, if the deviation is normal than it is considered to be normal traffic being generated by the one or more advertisements 148. Further, if the deviation is high than it is considered as the large amount of incentivized traffic has been added to the traffic data. In an example, if the deviation is 1 than it is considered as normal traffic for the traffic data for the slots of install.

Also, the fraud identification system 156 analyzes the slots of install for which difference between the average of the high conversion rate and the low conversion rate is above a pre-threshold. The analysis is done in real time. The difference is above the pre-threshold indicates that incentivized traffic mixing has been performed by the publisher 146. The pre-threshold is the threshold which has been provided by the one or more advertisers 154. In an embodiment of the present disclosure, the pre-threshold has calculated by the fraud identification system 156.

In an embodiment of the present disclosure, the fraud identification system 156 determines incentive time for which incents mixing was performed by the publisher 146. The determination is done based on the analysis of the slots of install. The incentive time is the time period for which the incentive is provided to the plurality of users 142 for clicking or installing an application though the one or more advertisements 148. The determination is done in real time.

Also, the fraud identification system 156 adds the publisher 146 in the blacklist. The publisher 146 is added in the blacklist by the blacklisting engine 156D. The blacklist contains the list of publishers 146 performing fraud for generating incentivized traffic. The blacklisting engine 156D contains the blacklist and white list which is stored in the database 160. The white list contains the list of publishers 146 providing genuine traffic for the one or more advertisements 148.

Also, the fraud identification system 156 generates report of the traffic data based on the segregation of the traffic data. The report is generated based on the analysis containing the list of the publishers 146 performing fraud. Also, the fraud identification system 156 blocks the publisher 146 performing fraud in the one or more advertisements 148 based on the analysis of the traffic data. The blocking of the publisher 146 performing fraud is blocked by the blacklisting engine 156D of the fraud identification system 156. The blocking is done in real time. The blocking is done of the publishers 146 providing fraud incentivized traffic. In an embodiment of the present disclosure, the fraud identification system 156 send list of the one or more advertisers 154 performing incent mixing and providing incentivized traffic.

In an embodiment of the present disclosure, the fraud identification system 156 receives user interaction after installing the application shown as the one or more advertisements 148 to the plurality of users 142. Further, the fraud identification system 156 analyzes the user interaction in order to identify if the activity of the plurality of users 142 is genuine. The analysis is done by identifying the correlation between the high conversion rate and low conversion rate to identify the installation being incentivized. In an example, if a user X is installing an application for first time and using the application after installation based on the user interaction than the traffic is not-incentivized.

The interactive computing environment 100 further includes the database 160 as shown in FIG. 1A is where all the information is stored for accessing. The database 160 includes data which is pre-stored in the database and data collected in real-time. The database 160 may be a cloud database or any other database based on the requirement for the fraud detection. The data is stored in the database 160 in various tables. The tables are matrix which stored different type of data. In an example, one table may store data related to the plurality of users 142 and in other table the plurality of media devices 144 related data is stored. The database 160 is included inside the server 158.

The server 158 is used to perform task of accepting request and respond to the request of other functions. The server 158 may be a cloud server which is used for cloud computing to enhance the real time processing of the system and using virtual space for task performance. In an embodiment of the present disclosure, the server 158 may be any other server based on the requirement for the fraud identification system 156.

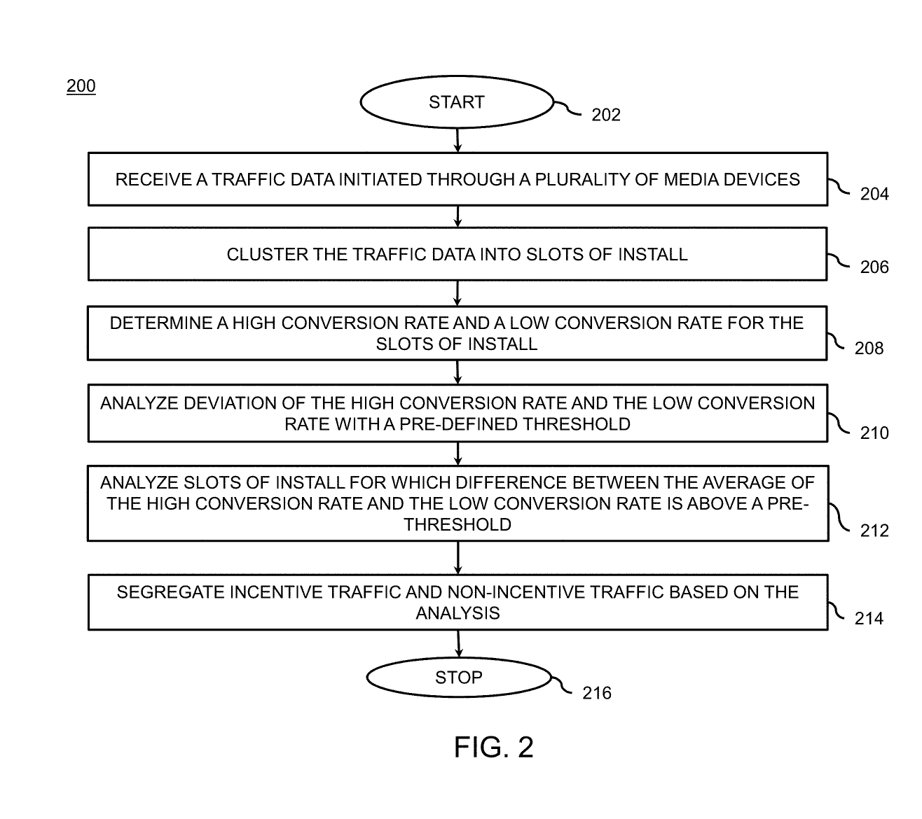

FIG. 2 illustrates a flow chart 200 for detecting advertisement fraud based on incentive and non-incentive traffic, in accordance with various embodiments of the present disclosure. It may be noted that to explain the process steps of flowchart 200, references will be made to the system elements of FIG. 1A and FIG. 1B. It may also be noted that the flowchart 200 may have fewer or more number of steps.

The flowchart 200 initiates at step 202. Following step 202, at step 204, the fraud identification system 156 receives a traffic data initiated through a plurality of media devices 144. At step 206, the fraud identification system 156 clusters the traffic data into the slots of install based on one of the plurality of criteria. At step 208, the fraud identification system 156 determines the high conversion rate and the low conversion rate for the slots of install. At step 210, the fraud identification system 156 analyzes deviation of the high conversion rate and the low conversion rate with a pre-defined threshold. At step 212, the fraud identification system 156 analyzes the slots of install for which difference between the average of the high conversion rate and the low conversion rate is above the pre-defined threshold. At step 214, the fraud identification system 156 segregates the incentive traffic and the non-incentive traffic based on the analysis. The flow chart 200 terminates at step 216.

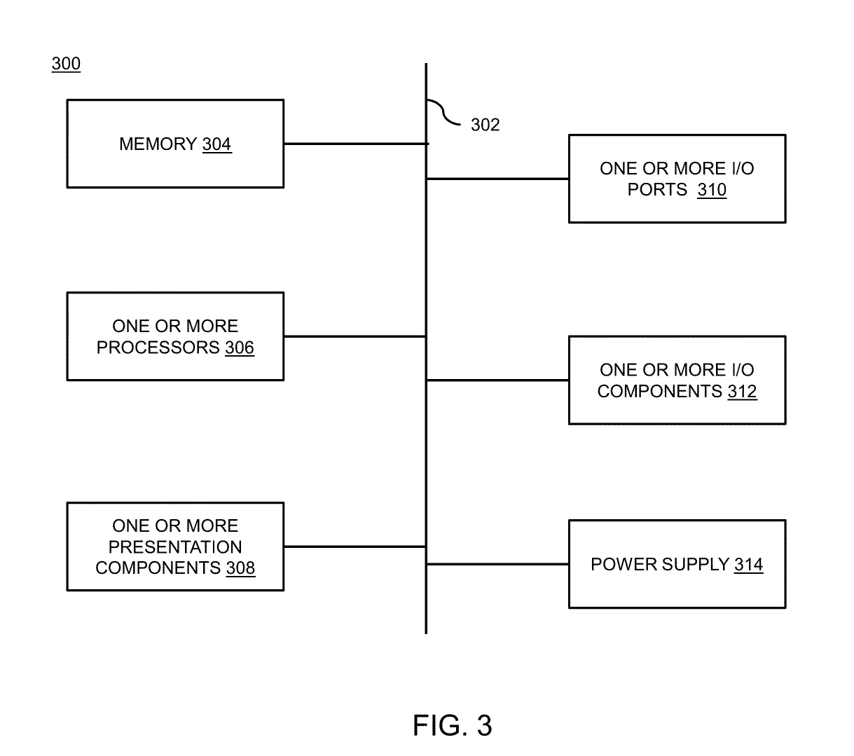

FIG. 3 illustrates a block diagram of a device 300, in accordance with various embodiments of the present disclosure. The device 300 is a non-transitory computer readable storage medium. The device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The device 300 includes the one or more processors 306 that read data from various entities such as memory 304 or I/O components 312. The one or more presentation components 308 present data indications to the user or other device. Exemplary presentation components include a display device, speaker, printing component, vibrating component, etc. The one or more I/O ports 310 allow the device 300 to be logically coupled to other devices including the one or more I/O components 312, some of which may be built in. Illustrative components include a microphone, joystick, gamepad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer system comprising:
one or more processors; and
a memory coupled to the one or more processors, the memory for storing instructions which, when executed by the one or more processors, cause the one or more processors to perform a method for detecting advertisement fraud based on incentive traffic and non-incentive traffic, the method comprising:
receiving, at a fraud identification system, a traffic data initiated through a plurality of media devices, wherein the traffic data is generated when one or more advertisements are viewed on at least one publisher on the plurality of media devices;
clustering, at a fraud identification system, the traffic data into slots of install, wherein the clustering is done based on one of a plurality of criteria by an adaptive slot grouping engine, wherein the clustering is done after receiving the traffic data in real time;
determining, at the fraud identification system, a high conversion rate and a low conversion rate for the slots of install, wherein the determination is done by using segmentation statistical models in real time, wherein the determination is done for the slots of install where the number of install is above a minimum install based on examination of user behavior;
analyzing, at the fraud identification system, deviation of the high conversion rate and the low conversion rate with a pre-defined threshold, wherein the analysis is done to identify fraud in the traffic data, wherein the analysis is done when a signal generator circuitry embedded inside a plurality of media devices generates a signal to trigger one or more hardware components of the plurality of media devices;
analyzing, at the fraud identification system, slots of install for which difference between the average of the high conversion rate and the low conversion rate is above a pre-threshold, wherein the analysis is done in real time; and
segregating, at the fraud identification system, incentive traffic and non-incentive traffic based on the analysis, wherein the segregation is done to generate report of the traffic data, wherein the segregation is done to determine an incentive time in real time.

2. The computer system as recited in claim 1, wherein the plurality of criteria comprises of a number of installs, time-interval and historical trends.

3. The computer system as recited in claim 1, wherein the device data comprises a number of application install, a number of application uninstalled, time-stamp, location, operating system, network type, service provider, location, model number, network speed and device type.

4. The computer system as recited in claim 1, wherein the application data comprises network download time, application usage time, application idle time, application opening time, application size, time to download, time to run, click to install, click to run, user click time, device load time, time to run and time to install.

5. The computer system as recited in claim 1, further comprising,
identifying, at the fraud identification system, the user behavior from device data, application data, past data and third party database, wherein the user behavior comprises user routine, time stamp, user interactions and application usage data.

6. The computer system as recited in claim 1, further comprising,
examining, at the fraud identification system, the user behavior to identify a downtime and the minimum install, wherein the examination is done based on real-time data and user behavior, wherein the examination is done in real time.

7. The computer system as recited in claim 1, further comprising,
determining, at the fraud identification system, the incentive time for which incent mixing is performed based on the analysis, wherein the determination is done in real time.

8. The computer system as recited in claim 1, further comprising
blocking, at the fraud identification system, the publisher performing fraud in the one or more advertisements based on the analysis of the traffic data, wherein the blocking is done in real time.

9. A computer-implemented method for detecting advertisement fraud based on incentive and non-incentive traffic, the computer-implemented method comprising:
receiving, at a fraud identification system with a processor, a traffic data initiated through a plurality of media devices, wherein the traffic data is generated when one or more advertisements are viewed on at least one publisher on the plurality of media devices;
clustering, at the fraud identification system with the processor, the traffic data into slots of install, wherein the clustering is done based on one of a plurality of criteria by an adaptive slot grouping engine, wherein the clustering is done after receiving the traffic data in real time;
determining, at the fraud identification system with the processor, a high conversion rate and a low conversion rate for the slots of install, wherein the determination is done by using segmentation statistical models in real time, wherein the determination is done for the slots of install where the number of install is above a minimum install based on examination of user behavior;
analyzing, at the fraud identification system with the processor, deviation of the high conversion rate and the low conversion rate with a pre-defined threshold, wherein the analysis is done to identify fraud in the traffic data, wherein the analysis is done when a signal generator circuitry embedded inside a plurality of media devices generates a signal to trigger one or more hardware components of the plurality of media devices;
analyzing, at the fraud identification system with the processor, slots of install for which difference between the average of the high conversion rate and the low conversion rate is above a pre-threshold, wherein the analysis is done in real time; and
segregating, at the fraud identification system with the processor, incentive traffic and non-incentive traffic based on the analysis, wherein the segregation is done to generate report of the traffic data, wherein the segregation is done to determine an incentive time in real time.

10. The computer-implemented method as recited in claim 9, wherein the plurality of criteria comprises of a number of installs, time-interval and historical trends.

11. The computer-implemented method as recited in claim 9, wherein the device data comprises a number of application install, a number of application uninstalled, time-stamp, location, operating system, network type, service provider, location, model number, network speed and device type.

12. The computer-implemented method as recited in claim 9, wherein the application data comprises network download time, application usage time, application idle time, application opening time, application size, time to download, time to run, click to install, click to run, user click time, device load time, time to run and time to install.

13. The computer-implemented method as recited in claim 9, further comprising,
identifying, at the fraud identification system with the processor, the user behavior from device data, application data, past data and third party database, wherein the user behavior comprises user routine, time stamp, user interactions and application usage data.

14. The computer-implemented method as recited in claim 9, further comprising,
examining, at the fraud identification system with the processor, the user behavior to identify a downtime and the minimum install, wherein the examination is done based on real-time data and user behavior, wherein the examination is done in real time.

15. The computer-implemented method as recited in claim 9, further comprising,
determining, at the fraud identification system with the processor, the incentive time for which incent mixing is performed based on the analysis, wherein the determination is done in real time.

16. The computer-implemented method as recited in claim 9, further comprising
blocking, at the fraud identification system with the processor, the publisher performing fraud in the one or more advertisements based on the analysis of the traffic data, wherein the blocking is done in real time.

17. A non-transitory computer-readable storage medium encoding computer executable instructions that, when executed by at least one processor, performs a method for detecting advertisement fraud based on incentive and non-incentive traffic, the method comprising:
receiving, at a computing device, a traffic data initiated through a plurality of media devices, wherein the traffic data is generated when one or more advertisements are viewed on at least one publisher on the plurality of media devices;
clustering, at the computing device, the traffic data into slots of install, wherein the clustering is done based on one of a plurality of criteria by an adaptive slot grouping engine, wherein the clustering is done after receiving the traffic data in real time;
determining, at the computing device, a high conversion rate and a low conversion rate for the slots of install, wherein the determination is done by using segmentation statistical models in real time, wherein the determination is done for the slots of install where the number of install is above a minimum install based on examination of user behavior;
analyzing, at the computing device, deviation of the high conversion rate and the low conversion rate with a pre-defined threshold, wherein the analysis is done to identify fraud in the traffic data, wherein the analysis is done when a signal generator circuitry embedded inside a plurality of media devices generates a signal to trigger one or more hardware components of the plurality of media devices;
analyzing, at the computing device, slots of install for which difference between the average of the high conversion rate and the low conversion rate is above a pre-threshold, wherein the analysis is done in real time; and
segregating, at the computing device, incentive traffic and non-incentive traffic based on the analysis, wherein the segregation is done to generate report of the traffic data, wherein the segregation is done to determine an incentive time in real time.
